(19) United States
(12) Patent Application Publication
(10) Pub. No.: US 2003/0112968 A1
(43) Pub. Date: Jun. 19, 2003

(54) Abuse resistant tapered safety telephone

(76) Inventor: Mark Styron, Pasadena, TX (US)

Correspondence Address: Keeling Hudson L.L.C., 901 N. Post Oak Road, Houston, TX, 77024, US

(21) Appl. No.: 10/352,611

(22) Filed: Jan. 28, 2003

Related U.S. Application Data
(63) Continuation-in-part of application No. 09/709,753, filed on Nov. 11, 2000, now Pat. No. 6,512,828.
Application No. 09/709,753 is a continuation-in-part of application No. 09/459,314, filed on Dec. 10, 1999, now abandoned.
Application No. 09/459,314 is a continuation-in-part of application No. 09/017,982, filed on Feb. 3, 1998, now Pat. No. 6,009,169.

(51) Int. Cl. H04M 1/00

(52) U.S. Cl. 379/441

(57) ABSTRACT

A telephone using conventional telephone mechanical and electrical components mounted within a telephone housing, typically mounted on a wall, with the earpiece and mouthpiece mounted to be protected by the telephone housing. The housing has a front face surrounded by tapered edges, which provide angled transitions from the front face to the mounting surface. To operate, the user pushes an on/off switch and places an ear next to the fixed earpiece. The telephone is designed for use in prisons, so inmates within a prison cannot hang themselves with a handset cord or break a handset and handset cord off for use as a weapon. The tapered edges restrict access to the abrupt sides of the rigid housing, so the phone does not protrude as a blunt object from the wall. The telephone, which may include a payphone escrow system, is also suitable for use in any high crime or remote public areas to reduce the potential for vandalism. The telephone design reduces the cost of maintenance by eliminating the need to fix and replace a telephone handset, or damaged housings.

### CROSS-REFERENCE TO RELATED APPLICATIONS

This is a continuation-in-part under 37 CFR 1.53(b) to application Ser. No. 09/709,753, filed on Nov. 11, 2000, which is a continuation-in-part application under 37 CFR 1.53(b) to application Ser. No. 09/459,314, filed on Dec. 10, 1999, abandoned, which is a continuation-in-part application under 37 CFR 1.53(b) to application Ser. No. 09/017,982, filed on Feb. 3, 1998, now U.S. Pat. No. 6,009,169.

### STATEMENT REGARDING FEDERALLY SPONSORED RESEARCH OR DEVELOPMENT

Not applicable.

### BACKGROUND OF THE INVENTION

1. Field of the Invention

This invention relates generally to telephone equipment and more specifically to a structure for a telephone for use by inmates or in other environments wherein the telephone is subject to abuse (hereinafter referred to as an safety telephone).

2. Description of the Related Art

Numerous hands-free telephone equipment systems have been taught in prior art. U.S. Pat. No. 2,277,907 issued to Goodale, Jr. et al. discloses a speaker attachment for a conventional telephone. U.S. Pat. No. 3,144,513 issued to Sherron teaches a partially enclosed telephone stall with a microphone and speaker mounted in the enclosure wall of the booth. U.S. Pat. No. 4,101,735 issued to Bridenbaugh uses a shared transducer, alternatingly functioning as a speaker and a microphone, connected to a conventional telephone. U.S. Pat. No. 4,104,485 issued to Pessel et al. discloses a loudspeaker system mounted over a conventional telephone. U.S. Pat. No. 5,371,790, issued to Nevo et al., discloses a telephone such that a mouthpiece, an earpiece, an electronic circuit board, a push-button dialing pad and a dial tone actuating switch are contained in a single housing and which places the entire phone in a housing similar to a conventional telephone handset. The Nevo et al. '790 patent does not teach safety and vandal resistance elements; in fact, the entire phone or alternatively the exterior connection cable may easily be used as a weapon. None of the prior art utilizes a design for a telephone that can be wall mounted and is self-contained with minimal external parts as described herein.

It would be an improvement to the field to have an inmate phone, which contains conventional telephone mechanical and electrical components mounted within a telephone housing, typically mounted on a wall, with the earpiece and mouthpiece mounted within the housing to serve as a hands-free telephone, with the housing tapered to provide an oblique transition from the front of the phone to the mounting surface for safety. Inmates within a prison would not be able to hang themselves with a handset cord or break off the handset and handset cord to use as a weapon. The phone would not provide an sharply angled protruding surface. Individuals would not be able to vandalize the safety phone handset or even rip the entire phone off the mounting structure. This phone reduces repairs by eliminating the need to fix and replace the telephone handset, thereby saving money for the cost of maintenance.

### BRIEF SUMMARY OF THE INVENTION

Accordingly, the objectives of this invention are to provide, inter alia, a new and improved telephone that:

provides hands-free operation;

is easy to use;

is economical to manufacture;

is resistant to vandalism and thus low-maintenance;

can be mounted on a wall;

reduces the amount of exposed blunt edge to the telephone when it is mounted on a wall;

eliminates available prying surfaces to the telephone when it is mounted on a wall; and

has no external cord, handset or other external parts that could be used as a weapon or means for vandalism or self-injury.

To the accomplishment of the above and related objects, this invention may be embodied in a mountable telephone that uses standard telecommunication and electronic components, including a handset or separate earpiece and mouthpiece, a push-button dialing pad, electronic circuitry, and switching circuitry, protected by a hard housing. The inventive telephone comprising a telephone housing, having a front face surface oriented generally parallel to and only slightly extending from a mounting surface, with the housing possessing transitional surfaces that gradual extend from the edges of the front face surface to the mounting surface, thereby providing minimal exposed edge and prying surface. The telephone, which may include a payphone escrow system, is also suitable for use in jails and prisons, or any high crime or remote public areas to reduce the potential for injury or vandalism. The drawings are illustrative only, and changes may be made in the specific construction illustrated and described within the scope of the appended claims. Other objects of the invention will become apparent from time to time throughout the specification hereinafter disclosed.

### BRIEF DESCRIPTION OF THE DRAWINGS

FIG. 1 is a perspective view of an interior portion of a prison, showing the present invention mounted into a wall thereof.

FIG. 2 is an alternate front perspective view of the embodiment of FIG. 1.

FIG. 3A is a rear perspective view of the embodiment of FIG. 1.

FIG. 3B is a rear perspective view of an alternate exemplary embodiment.

FIG. 4 is a front view of the invention, further showing diagrammatically an electrical circuit incorporating a volume control for the earpiece and mouthpiece.

FIG. 5A is a cross-sectional view of housing of FIG. 3A, cut along line 5A-5A.

FIG. 5B is a cross-sectional view of housing of FIG. 3B, cut along line 5B-5B.

FIG. 6 is a perspective view of an exemplary embodiment of the present invention housing an escrow mechanism.

Similar reference characters denote corresponding features consistently throughout the attached drawings.

### DESCRIPTION OF THE INVENTION

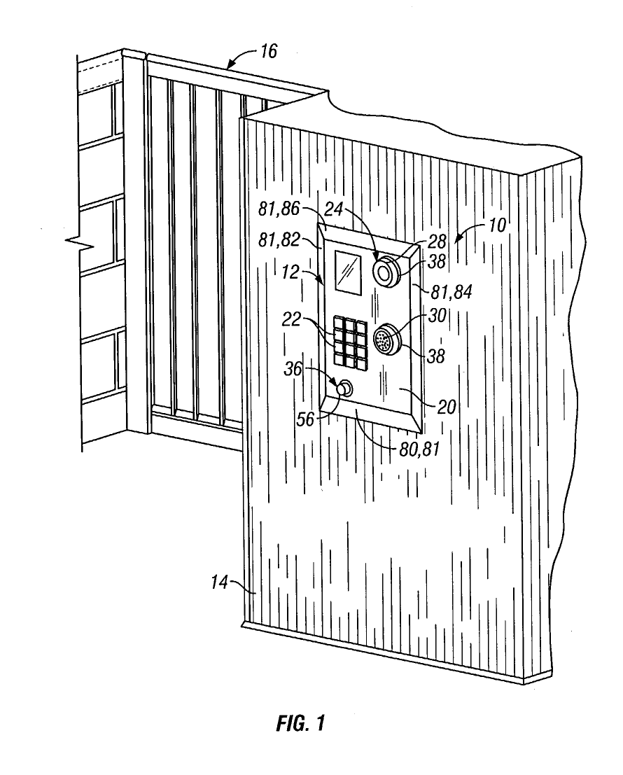

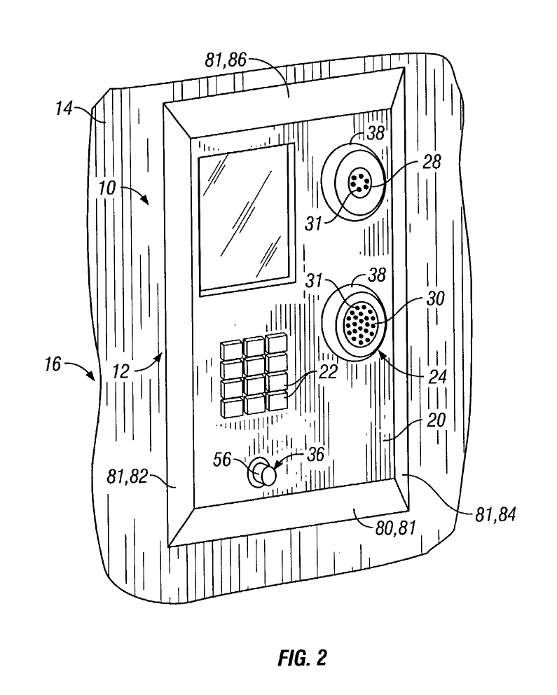

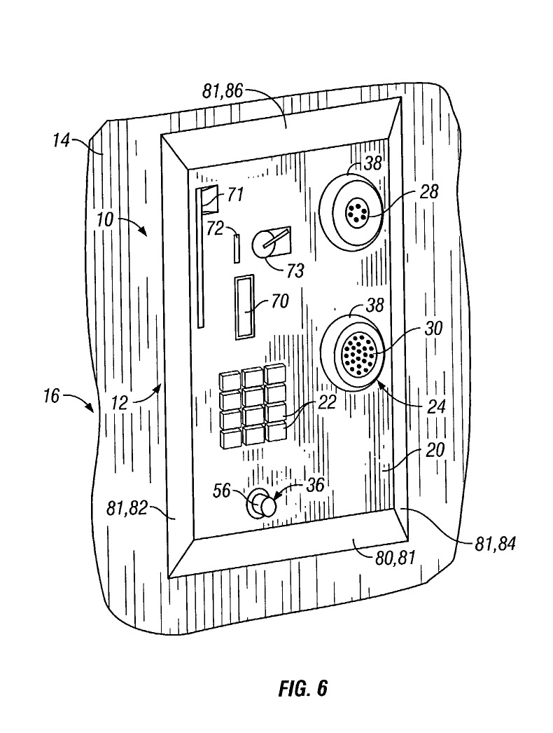

The present invention is a telephone described as safety phone 10, generally depicted in FIGS. 1-4, of the type having housing 12, capable of being mounted to a building wall, such as mounting surface 14 of prison 16. While safety phone 10 is described as being mounted and used in prison 16, it is understood that safety phone 10 may be used, mounted or free standing, in any location where a telephone is desired that encompasses the safety and security features described herein. Referring to FIG. 6, safety phone 10 may be modified for use with coin or card payment mechanisms using standard methods and electrical/mechanical designs for this feature.

Referring to FIGS. 1-4, safety phone 10 may be mounted directly onto or recessed into a mounting surface 14, so that only a portion of housing 12 is accessible to a user. In the exemplary embodiment, the mounting surface 14 is a prison wall 16. Housing 12 includes a housing front wall 20 and sidewalls 26. Housing front wall 20 includes a front wall inner surface 21. Sidewalls 26 extend from the perimeter of front wall inner surface 21 to create a protective enclosure within housing 12.

An interface element 81 is provided intermediate housing 12 and mounting surface 14, when the phone is in a mounted position. Interface element 81 extends around the perimeter of housing front wall 20 and extends angularly from the plane of housing front wall 20 to the mounting surface 14. Interface element 81 comprises left tapered element 82, right tapered element 84, top tapered element 86 and bottom tapered element 80. Left tapered element 82, right tapered element 84, top tapered element 86 and bottom tapered element 80 are flanges extending from front wall 20 so as to angle toward the mounting surface 14. Tapered elements 80, 82, 84 and 86 extend outwardly from the perimeter of housing front wall 20 at an obtuse angle to provide a gradual slope, or taper, from the surface of housing front wall 20 to mounting surface 14. In this fashion, safety phone 10 is able to restrict access to housing sidewalls 26 extending outwardly from mounting surface 14. Such restriction limits the ability of a vandal or thief to effectively damage sidewalls 26 or gain a leverage advantage against the abrupt angle of sidewalls 26.

In the exemplary embodiment, front wall 20 and mounting surface 14 are in generally parallel planes, and top tapered element 86, bottom tapered element 80, left tapered element 82 and right tapered element 84 are attached to front wall 20 and contact mounting surface 14 at obtuse angles from the parallel planes of front wall 20 and mounting surface 14. In an alternate embodiment (not shown) of the inventive safety phone 10, tapered elements 80, 82, 84 and 86 are of different dimensions in order to provide gentle transition angles from the plane of front wall 20 to the plane of mounting surface 14 when these two planes are not completely parallel. The plane of housing front wall 20 may be skewed in relationship to the plane of mounting surface 14 in order to present front wall 20 to a potential user in a more convenient attitude. A phone with a front wall 20 so skewed is still within the scope of this disclosure if top tapered element 86, bottom tapered element 80, left tapered element 82 and right tapered element 84 are able to provide a tapered angle between the planes of front wall 20 and mounting surface 14.

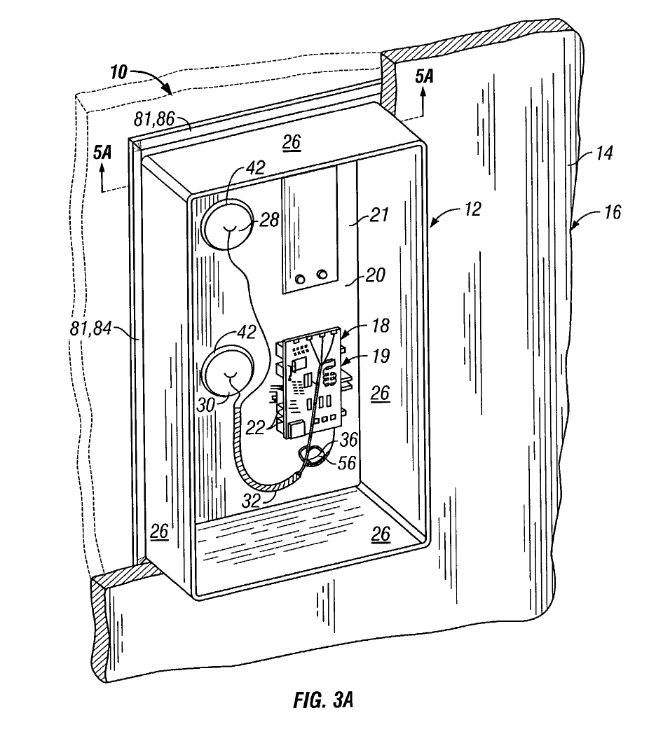

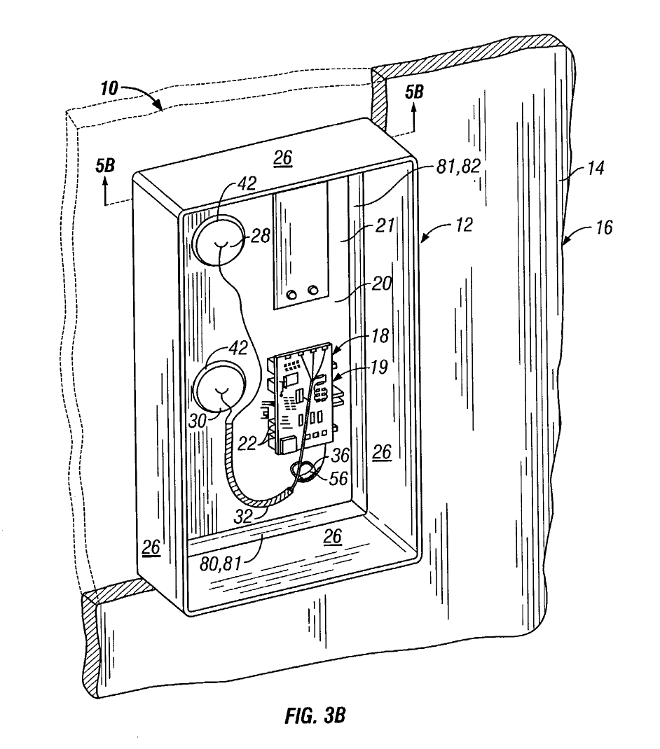

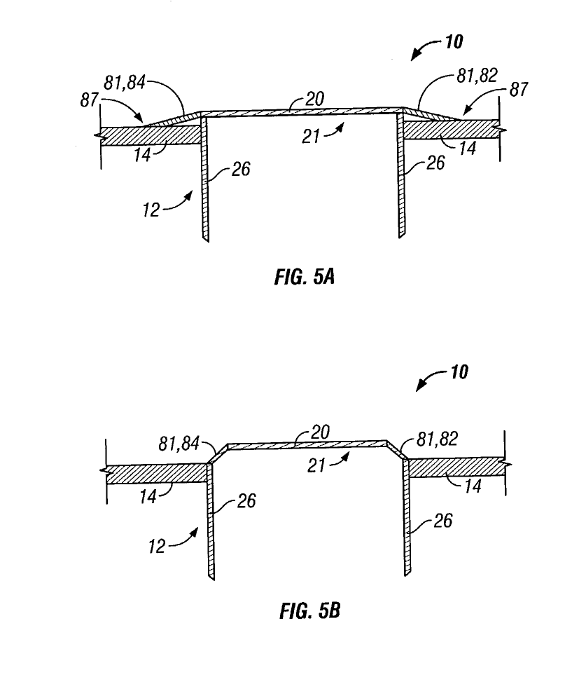

Referring to FIGS. 3A and 5A, in the exemplary embodiment, housing 12 is recessed into mounting surface 14 such that tapered elements 80, 82, 84 and 86 are proximate to mounting surface 14. Tapered elements 80, 82, 84 and 86 create tapered angles between the planes of front wall 20 and mounting surface 14. With housing 12 recessed into mounting surface 14, the sidewalls 26 of safety phone 10 are no longer exposed to access from the front by a user. Tapered elements 80, 82, 84 and 86 cover the interface between mounting surface 14 and phone sidewalls 26. In the exemplary embodiment, tapered elements 80, 82, 84 and 86 have a beveled end 81, which provides a flush interface to mounting surface 14.

Referring to FIGS. 3B and 5B, in an alternate exemplary embodiment, tapered elements 80, 82, 84 and 86 create tapered angles between the planes of front wall 20 and mounting surface 14. With housing 12 recessed into mounting surface 14, the sidewalls 26 of safety phone 10 are no longer exposed to access from the front by a user. Tapered elements 80, 82, 84 and 86 are proximate to sidewalls 26 at the intersection of housing 12 and mounting surface 14, in order to restrict access by a user to the abrupt angles of sidewalls 26.

In an alternative exemplary embodiment housing 12 does not include sidewalls 26. Housing 12, comprising housing front wall 20 and interface element 81, provides the protection to the internal working mechanisms by being secured directly to mounting surface 14 by a mounting bracket (not shown).

Located behind or within housing 12, and typically attached to front wall inner surface 21, are electronic circuit board 19, earpiece 28 and mouthpiece 30. Typically, push-button dialing pad 18 is a component of electronic circuit board 19, which is mounted to the front wall inner surface 21. In an alternative embodiment, push-button dialing pad 18 can be separate from electronic circuit board 19 and electrically connected. A plurality of push-button digits 22 of push-button dialing pad 18 extends outward through push-button apertures 23 through housing front wall 20. Plurality of push-button digits 22 extend a sufficient distance to afford full travel distance for each of the push-button digits 22 to effect activation of the electric information switch associated with each push-button digit 22.

Aural output and input to safety phone 10 is provided respectively by earpiece 28 and mouthpiece 30, both being mounted to the interior of housing front wall 20 and extending outward from housing front wall 20 through aural apertures 38. Earpiece 28 and mouthpiece 30 may be referred to collectively as a handset.

Earpiece 28 and mouthpiece 30 are each electrically connected to electronic circuit board 19 by connection wire 32. Earpiece 28 and mouthpiece 30 are mounted such that earpiece 28 is positioned above mouthpiece 30. Earpiece 28 and mouthpiece 30 are affixed to housing front wall 20 using any appropriate form of attachment known in the art. Attachment methods may include, but are not limited to, adhesives, mechanical clamps (not shown) interior to housing 12, or other devices, which securely mount earpiece 28 and mouthpiece 30 to housing 12, such that they cannot be removed via the exterior of housing 12. In the exemplary embodiment, annular seal 42 seals earpiece 28 and mouthpiece 30 into aural apertures 38. Each annular seal 42 extends about earpiece 28 and mouthpiece 30 within the two vertically spaced apart sound transparent sections or apertures 38 in the housing front wall 20 of the housing 12. The exemplary earpiece 28 and mouthpiece 30 extend from housing front wall 20, and are contoured and spaced apart to present an ergonomic external surface for a user to position an ear comfortably adjacent to earpiece 28 and mouth adjacent to mouthpiece 30. In the exemplary earpiece 28 and mouthpiece 30, sound transparent sections are in the form of a plurality of small holes 31.

In an alternative embodiment, earpiece 28 and mouthpiece 30 are mounted within safety phone 10, such that no portions of earpiece 28 or mouthpiece 30 extend through housing front wall 20. In the exemplary embodiment, earpiece 28 and mouthpiece 30 attach to front wall inner surface 21. In this embodiment, aural communication to earpiece 28 and mouthpiece 30 is afforded through a sound transparent section of housing front wall 20, such as a solid acoustic transmitter (not shown). The sound transparent regions are contoured and spaced apart to present an ergonomic external surface on housing front wall 20 for a user to position an ear comfortably adjacent to earpiece 28 and mouth adjacent to mouthpiece 30. This sound transparent section provides protection to earpiece 28 and mouthpiece 30, while allowing sound to pass.

Dial tone actuating switch 36 extends through housing front wall 20 of housing 12 via dial tone actuating switch aperture 37, for manually actuating the dial tone of the safety phone 10. In the exemplary embodiment, actuating component 36 is an on/off push-button switch 56 as is known in the art. Push button switch 56 may require constant pressure applied by the telephone user to maintain electrical circuit continuity, or may be a toggle push button requiring a first depression to actuate and a second depression to deactuate. In an alternative embodiment, actuating component 36 may be any on/off electrical switch capable of completing an electric circuit, including but not limited to a toggle lever switch, a relay or a breaker switch. Actuating component 36 is limited dimension to prevent injury to the user from being struck by actuating component 36 or its related structure, and for actuating component 36 to be ergonomically correct for proper usage. This ergonomic correctness includes proper positioning on housing front wall 20, proper throw distance of actuating component 36, and absence of surround structure, such as a phone hook, that creates an ergonomic hazard. Dial tone actuating switch 36 is electrically connected between phone line 58 and electronic circuit board 19. Typically, phone line 58, providing electrical access to the remote telephone routing switching equipment, enters housing 12 through the wall mounting plate (not shown) behind mounted housing 12, such that phone line 58 is not exposed to vandalism or environmental damage.

Earpiece 28, mouthpiece 30 and push-button dialing pad 18 are also electrically and functionally connected to electronic circuit board 19. Electronic circuit board 19 includes electronic components known in the art of telephone and electrical switching to receive electrical signals from mouthpiece 30 and phone line 58, to transmit electrical signals to earpiece 28 and phone line 58, and to receive and process electrical input from push-button dialing pad 18 for transmission to phone line 58. In the exemplary embodiment, safety phone 10 is capable of dialing out to another phone, but is not enabled to receive incoming phone calls.

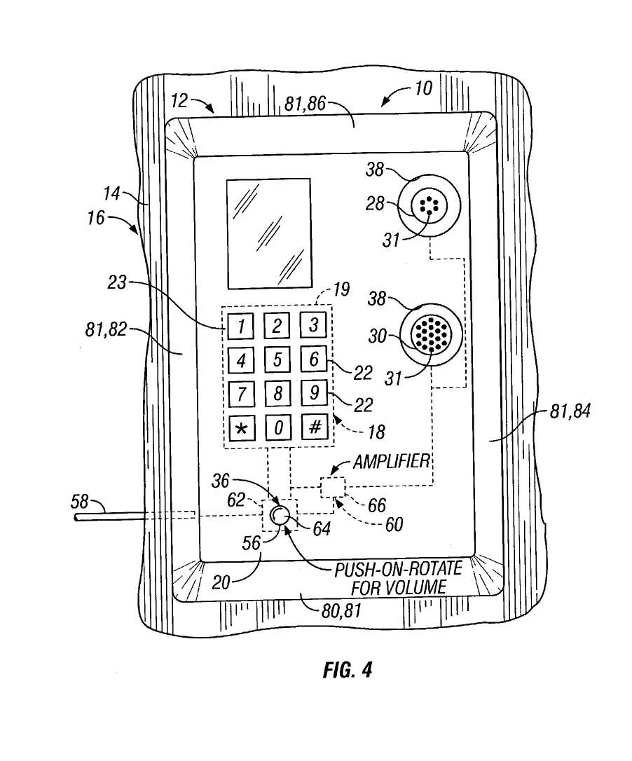

An assemblage 60, as shown in FIG. 4, can be electrically connected to earpiece 28 and mouthpiece 30 for increasing and decreasing sound coming out of earpiece 28 and sound going into mouthpiece 30. In one embodiment, the sound increasing and decreasing assemblage 60 consists of the on/off push-button switch 56 having a built-in volume control circuit 62 with a rotatable control knob 64.

Amplifier 66 is electrically connected between volume control circuit 62 and earpiece 28 and mouthpiece 30. Typically, amplifier 66 is a component of electronic circuit board 19. Typically, when the control knob 64 is manually rotated in a clockwise direction, the sound coming out of the earpiece 28 and the sound going into the mouthpiece 30 will be increased. When the control knob 64 is manually rotated in a counterclockwise direction, the sound coming out of the earpiece 28 and the sound going into the mouthpiece 30 will be decreased.

In the exemplary embodiment, safety phone 10 is mounted into mounting surface 14 at a height such that earpiece 28 is approximately level with the ear of an average height adult user. The transition from left tapered element 82, right tapered element 84, top tapered element 86 and bottom tapered element 80 to the wall each forms an oblique angle, so that the surfaces of the phone housing that are abrupt to mounting surface mounting surface 14 are no longer exposed to the public.

To use safety phone 10, the user actuates actuating component 36. With actuating component 36 actuated, safety phone 10 receives a dial tone and the user dials the desired phone number. The user then places his ear next to extended earpiece 28, or in the alternative embodiment next to the sound transparent section of housing front wall 20 in front of earpiece 28, to hear the person being called. The vertical orientation of mouthpiece 30 is such that mouthpiece 30 is ergonomically oriented below earpiece 28 for normal speech input into mouthpiece 30 when the user's ear is placed next to earpiece 28. In the exemplary embodiment, the volume for earpiece 28 and mouthpiece 30 is controlled by control knob 64 as described above. When the call is finished, the user disengages actuating component 36, either by releasing it or by depressing it a second time, depending on the type of switch used for actuating component 36.

In an alternative embodiment depicted in FIG. 6, safety payphone 10 is equipped with an escrow mechanism of a style known in the art designed to recognize the receipt of coins, currency or credit cards (referred to hereafter as payments) and enable operation of the telephone when the proper amount of payment has been introduced. Various payment receiving slots may be employed to facilitate the introduction of payment to telephone 10. In the embodiment depicted, housing front wall 20 may be provided with coin receiving slot 72, which allows for introduction of coin currency into the housing. The escrow mechanism is located so that the payment is deposited into coin box 87.

As is well known in the art, a coin return slot 70 may be included in housing front wall 20 for return of coin currency when appropriate. Alternative methods of receiving payment may be provided, such as a credit card receiving slot or paper currency receiver (not shown). As known in the art, the escrow mechanism receives the payment for calls and permits activation of the electronic circuit board 19 as long as appropriate payment is maintained.

To use safety payphone 10, the user deposits sufficient funds and actuates actuating component 36. With actuating component 36 actuated, safety payphone 10 receives a dial tone and the user dials the desired phone number. The user then places his ear next to extended earpiece 28, or in the alternative embodiment next to the sound transparent section of housing front wall 20 in front of earpiece 28, to hear the person being called. The vertical orientation of mouthpiece 30 is such that mouthpiece 30 is ergonomically oriented below earpiece 28 for normal speech input into mouthpiece 30 when the user's ear is placed next to earpiece 28. In the preferred embodiment, the volume for earpiece 28 and mouthpiece 30 is controlled by control knob 64 as described above. When the call is finished, the user disengages actuating component 36.

It is understood that each of the elements described above, or two or more together may also find a useful application in other types of methods differing from the type described above. While certain novel features of this invention have been shown and described are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A telephone for permanent mounting to a mounting surface in environments wherein the telephone is subject to abuse, said telephone attachable to a phone line routed within said mounting surface, said telephone comprising:
a housing, a mouthpiece, an earpiece, two sound transparent regions, a dial tone actuating switch and an electronic circuit board;
said mouthpiece, said earpiece, said dial tone actuating switch operationally connected to said electronic circuit board;
said housing having a front wall and an interface element;
said front wall having a perimeter; and
an interface element extending outwardly from said housing front wall perimeter at an obtuse angle to said housing front wall.

2. A telephone as in claim 1, further comprising:
said front wall having an inner surface;
said housing having a plurality of side walls;
said plurality of side walls extending from said housing normal said front wall inner surface; and
said plurality of side walls connected to said housing intermediate said front wall and said interface element.

3. A telephone as in claim 2, further comprising:
said interface element having an interface edge distal said side walls; and
said interface edge beveled.

4. A telephone as in claim 1, further comprising:
said front wall having an inner surface;
said housing having a plurality of side walls;
said plurality of side walls extending from said housing normal said front wall inner surface; and
said plurality of side walls connected to said interface element distal said front wall.

5. A telephone as in claim 1, further comprising:
said two sound transparent regions contoured and spaced apart to present an ergonomic external surface to said housing for positioning of a user's ear and mouth adjacent thereto.

6. A telephone as in claim 1, wherein:
said electronic circuit board connectable to said telephone line behind said housing front wall and behind said interface element.

7. A telephone as in claim 1, wherein:
said electronic circuit board connectable to said telephone line within said housing.

8. A telephone as in claim 1, further comprising:
said two sound transparent regions being a plurality of aural apertures in said housing front wall; and
said earpiece and said mouthpiece each being secured to said aural apertures.

9. A telephone as in claim 8, wherein:
said mouthpiece and said earpiece extending outward from said housing through said aural apertures.

10. A telephone as in claim 9, further comprising:
said earpiece and said mouthpiece each being secured to said aural apertures by an annular seal.

11. A telephone as in claim 1, further comprising:
said housing front wall including at least one push-button aperture and a dial tone actuating switch aperture;
a push-button dialing pad mounted to said housing front wall; and
said push-button dialing pad functionally accessible at a front surface of said housing front wall.

12. A telephone as in claim 1, further comprising:
said housing front wall including a dial tone actuating switch aperture; and
said dial tone actuating switch mounted to said housing front wall and functionally accessible through said dial tone actuating switch aperture.

13. A telephone as in claim 1, further comprising:
said electronic circuit board electrically connected to an escrow mechanism;
said housing including payment receiving slots; and
said escrow mechanism operatively connected to said payment receiving slots.

14. A telephone as in claim 13, wherein said telephone is mounted on a wall in a public area.

15. A telephone as in claim 14, wherein said telephone is mounted on a pedestal in a public area.

16. A telephone as in claim 1, wherein said telephone is mounted on a wall in a prison.

17. A telephone as in claim 1, wherein said telephone is mounted in a public area.

18. A telephone as in claim 1, wherein said telephone is mounted on a wall at a height and vertically oriented such that a user can stand adjacent said telephone with said user's ear proximate said earpiece and said user's mouth proximate said mouthpiece.

19. A telephone for permanent mounting to a mounting surface in environments wherein the telephone is subject to abuse, said telephone attachable to a phone line routed within said mounting surface, said telephone comprising:
a housing, a mouthpiece, an earpiece, a dial tone actuating switch and an electronic circuit board;
said housing having a front wall and an interface element;
said housing front wall having a plurality of aural apertures;
said earpiece and said mouthpiece each being secured to at least one of said plurality of aural apertures;
said mouthpiece, said earpiece, said dial tone actuating switch operationally connected to said electronic circuit board;
said front wall having a perimeter;
an interface element extending outwardly from said housing front wall perimeter at an obtuse angle to said housing front wall; and
said front wall having an inner surface.

20. A telephone as in claim 19, further comprising:
said housing having a plurality of side walls;
said plurality of side walls extending from said housing normal said front wall inner surface; and
said plurality of side walls connected to said front wall and said interface element.
